(19) United States
(12) Patent Application Publication
(10) Pub. No.: US 2024/0264582 A1
(43) Pub. Date: Aug. 8, 2024

(54) METHOD, COMPUTER PROGRAM PRODUCT AND SYSTEM FOR PROVIDING SERVICES

(71) Applicant: Siemens Aktiengesellschaft, München (DE)

(72) Inventors: Jochen Balduf, Hambrücken (DE); Harald Albrecht, Nürnberg (DE); Frank Volkmann, Nürnberg (DE)

(21) Appl. No.: 18/290,802

(22) PCT Filed: Jul. 2, 2022
(86) PCT No.: PCT/EP2022/068820

§ 371 Date: Jan. 21, 2024

(30) Foreign Application Priority Data
Jul. 21, 2021 (EP) 21187022.5

(51) Int. Cl. G05B 19/418

(52) U.S. Cl. CPC G05B 19/4183; G05B 2219/31368

(57) ABSTRACT

The present invention relates to a method, a computer program product and a system for providing services, in particular in an industrial automation system. Users of control applications implemented for industrial automation systems by way of container virtualization expect the integration of such applications into their existing infrastructure to be as straightforward as possible. Depending on the network connection and the flow control environment used, in particular OPC UA servers encounter different configurations that need to be taken into consideration by developers of control applications for automated configuration methods for the control applications. For this purpose, a smart proxy for OPC UA servers in virtual machines or Docker environments, such as in Industrial Edge, is used and intervenes in the initially still unsecure service communication in order to ensure that OPC UA clients can successfully connect to OPC UA servers in a container host/Industrial Edge.

The invention relates to a method, a computer program product and a system for providing services, in particular in an industrial automation system.

Industrial automation systems usually comprise a multiplicity of automation devices networked to one another by way of an industrial communication network and, within the scope of production or process automation, are used to control or regulate installations, machines or devices. Time-critical constraints in industrial automation systems mean that predominantly y real-time communication protocols, as such PROFINET, PROFIBUS, real-time Ethernet or time-sensitive networking (TSN), are used for communication between automation devices. In particular, control services or applications can be distributed automatically over currently available servers or virtualized environments of an industrial automation system on a load-dependent basis.

Interruptions in communication connections between computer units of an industrial automation system or automation devices may result in undesirable or unnecessary repetition of the transmission of a service request. In addition, messages which have not been transmitted or have not been completely transmitted may prevent an industrial automation system from changing to or remaining in a safe operating state, for example.

Problems can arise in Ethernet-based communication networks if network resources for transmitting data streams or data frames with realtime demands are used in a competing manner to transmit data frames having a large payload content without specific quality of service demands. This can ultimately lead to data streams or data frames with realtime demands not being transmitted in accordance with a demanded or required quality of service.

With the Industrial Edge system, for example, automation technology users can install, and update expand the functionalities they want for their automation in a simple and modular manner in the form of so-called apps (applications). On the one hand, users benefit from centralized and easily scalable management of many Industrial Edge devices, and on the other hand from the market, which also includes third-party providers of these applications. Another important aspect is the desire of automation users to be able to install applications from different vendors simply and operate them immediately with as little additional integration effort as possible.

OPC UA (OPC Unified Architecture, www.opcfoundation.org) has established itself in automation technology for semantically high-quality and secure data exchange. Application providers increase the attractiveness of their apps by, for example, providing the data calculated by them from a production data analysis, image analysis and the like to other automation functions via an integrated OPC UA server. Compared to the classical device world, it is now necessary to integrate not only a classical device OPC server into the same (industrial edge) device, but multiple applications with OPC UA server functionality from different (third-party) providers.

Manual integration, as in the previous world of individual devices, is time-consuming and error-prone, sometimes even impossible due to the lack of configuration points in the OPC UA servers. However, this integration not only includes the applications in the device, but also the interaction of device-external components of the automation apps with the device apps.

If an OPC UA server application is executed in a virtualization solution such as a (Docker) container, then the application is initially free in the network resources it occupies, such as TCP ports in particular—in this case, port 4840 is predefined for an individual server, in particular with OPC UA.

In “OPC UA for Plug & Produce: Automatic Device Discovery using LDS-ME”, 2017 22^{nd} IEEE International Conference on Emerging Technologies and Factory Automation (ETFA) XP033292903, Stefan Profanter et al. describe such a method of simple plug-and-play integration.

Users of control applications realized using container virtualization or comparable virtualization concepts for industrial automation systems expect the most straightforward integration of such applications into their existing infrastructure. Depending on the network connection and the sequence control environment used, OPC UA servers in particular encounter widely differing user-side configurations, which must be taken into account by developers of control applications in automated configuration procedures for the control applications. When connecting to the network, the user faces particular challenges when integrating control applications into an existing infrastructure due to scarce IP-address and TCP port-number ranges.

However, the OPC UA server applications cannot be accessed from outside without additional measures, which means that the user has to place the server ports between the app view and the industrial edge device view, paying attention to port conflicts and compliance with possible restrictions on the network environment—such as the limited number of ports that can be enabled in firewalls and their specific value ranges or preset default rules can be used without any further (configuration) effort.

In addition, the automation technology user must link the other parts of their automation application with the servers via the specific network addressing information.

### PRIOR ART

The OPC Foundation describes the function of the “Local Discovery Server” LDS, via which the OPC UA servers can be discovered within a directly accessible network segment after the OPC UA servers have previously registered—via the so-called “RegisterServer” service—on the LDS.

The basic function of an OPC UA proxy is known.

For example, it acts in the same way as (Ingress) web proxies by forwarding the incoming connections on a common network port on the basis of additional criteria at the level of the OPC UA application layer (from the point of view of the ISO/OSI layer model).

The Local Discovery Server LDS maintains a list of all OPC UA applications.

In virtualization environments such as (Docker) containers, the problem exists that an OPC UA server can only register on the Local Discovery Server LDS with its “internal” network information (IP address/hostname and port). This internal network information is the network addresses and ports visible to the container itself, but these are fundamentally different from the external view at the level of a cluster or an Industrial Edge device.

The patent application with the application file number EP 20198692 A1 “Method and system for providing time-critical services by means of a process control environment” describes a mechanism for capturing the registration information from apps with OPC UA servers, for example, in a cloud system via so-called “sidecar” containers and to prepare it according to a desired cluster Ingress operating mode and make it available to the load balancer/Ingress units operated at the entry point of the cluster.

The earlier patent application with the application filing number EP 20193690.3 relates to a method for providing time-critical services to which at least one server component is assigned, which is formed by a sequence control component that can be loaded into a sequence control environment and executed there. For each server component, a functional unit for processing a communication protocol stack is made available, which is connected to a functional unit associated with the sequence control environment for processing a communication protocol stack. The services each include a directory service component for determining services provided by the sequence control environment. The directory service components are connected to each other via a separate communication interface. An aggregator component formed by means of an additional sequence control component is connected to the separate communication interface, which makes information about the services provided by the server components available outside the sequence control environment.

In the application cited above, no technical questions related to establishing a connection at the service level of OPC UA are resolved.

Existing service/device discovery procedures, in particular for OPC UA, are primarily designed to identify services that are made available for use by means of physical or virtual hypervisor-based machines. In particular, relatively high operating and maintenance costs for hypervisor-based virtual machines make virtualization concepts with lower resource requirements, such as container virtualization, increasingly attractive compared to full system virtualization. This also applies to industrial automation systems.

According to the OPC UA specifications, the Local Discovery Server LDS is intended for OPC-UA-based services. However, only hosts within a broadcast domain can be discovered using appropriate discovery methods. In addition, multicast communication within container virtualization systems is typically blocked.

Document US 2017/0111476 A1 also presents a means of integrating new Plug&Play resources into an existing network by means of a newly generated API in each case.

The object of the present invention is to create a method for providing services, which enables a reliable user-side determination of services provided by means of container virtualization or comparable virtualization concepts, and to provide a suitable device for carrying out the method.

This object is achieved according to the invention by a method having the features specified in claim 1, by a computer program product having the features specified in claim 9, and by a system having the features specified in claim 10.

Advantageous developments are reproduced in the dependent claims.

The claimed method for providing time-critical services to a service consumer using sequence control components in a sequence control environment comprises the following steps
each service is assigned at least one server component (UAS, 101), which is formed by a sequence control component that can be loaded into the sequence control environment and executed there,
at least one proxy component of a subnet comprising the sequence control environment accepts service requests,
a central directory service component (LDS, 201) transmits the addressing information valid within the subnet to the proxy component,
registration of the server component (UAS, 101) on the central directory service component (LDS, 201) with its internal connection data (111)
determination of globally valid access information assigned to addressing information of the server component (UAS, 101), which is valid within the subnet,
modification of the internal connection data (DiscoveryURI and/or EndpointURI) by means of the external network addressing information (102) determined in the central directory service component (LDS, 201),
   so that the at least one proxy component (UAP, 200) can forward service requests corresponding to the modified addressing information to the server component (UAS, 101).

The invention disclosed here specifies in more detail, building on patent application EP20198692 A1, the required function of the load balancer/Ingress units (“proxies”) for operation with OPC UA and in particular the operation of the endpoint determination of individual servers as well as the so-called OPC UA “secure sessions” at level 7 of the ISO/OSI layer model.

Sequence control components are in particular software containers that run in isolation from other software containers or container groups within the sequence control environment on host operating system of a server device. In principle, alternative micro-virtualization concepts, such as Snaps, can also be used for the sequence control components.

For example, the sequence control environment can comprise a Docker engine or Snap core running on a server device. Advantageously, the software containers in each case use a kernel of the host operating system of the server device, jointly with other software containers running on the respective server device. For example, stored images for the software containers can be retrieved from a storage and provision system which allows read and/or write access by a plurality of users.

Each server component is assigned a directory service component, which is used to implement a Local Discovery Service (directory service component 201). Such an approach is described in detail in the earlier European patent application with the application filing number EP 20193690.3, the disclosure content of which is referred to here. In this case, the directory service components transmit the addressing information valid within the subnet or the locally valid URLs via the matching unit to the configuration unit and to the aggregator component 104.

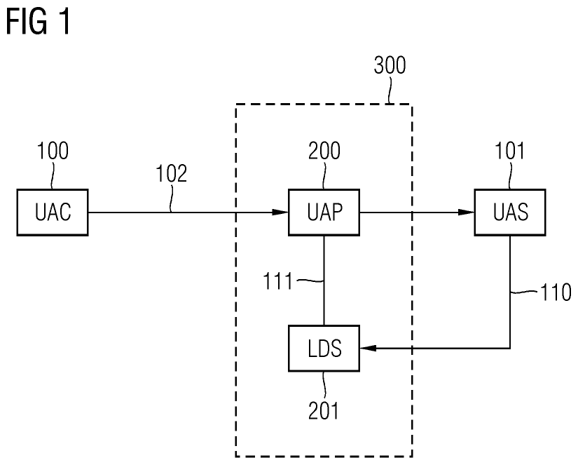

The solution proposed here is also shown in FIG. 1 using an example of Industrial Edge with OPC UA communication.

This illustrates an intelligent proxy for OPC UA servers in virtual machines or Docker environments, such as in Industrial Edge, which intervenes in the initially unsecured service communication to ensure that OPC UA clients can successfully connect to OPC UA servers in a container host/industrial edge.

The proposed proxy component UAP, 200 with Local Discovery Server functionality LDS, 201 can solve multiple problems at the same time.

On the one hand, OPC UA clients UAC, 100 can discover the plurality of OPC UA servers UAS, 101 installed on a single network device—such as an Industrial Edge/container host—using the Local Discovery Server LDS, 201.

The OPC UA servers UAS, 101 can be addressed via the proxy component UAP, 200 and preferably via only one port, such as the well-known port 4840, which improves the security aspects of the network topology from an administrative point of view.

It is also advantageous that the administrative view of the network resources is decoupled from the internal server or container view via the proxy component (200).

For the solution according to the invention it does not matter whether the functional units proxy component UAP, 200 and the directory service component, Local Discovery Server LDS, 201 are designed as one unit or as separate units (processes, programs, etc.). However, it is important to compare information (111) between the directory service component, Local Discovery Server LDS, 201 and the proxy component UAP, 200. The information 111 provided by the LDS enables the proxy component UAP, 200 to correctly forward connection requests from OPC UA clients UAC, 100 and to answer specific, still unencrypted parts (usually the beginning) of the communication relating to the service request either independently on the basis of the information 111 provided, or alternatively correctly rewrite the associated service responses (ACK).

In an advantageous embodiment, each service in its container can comprise a separate directory service component LDS and the registration of the server component (UAS, 101) is carried out on the directory service component (LDS) assigned to the service with its internal connection data (111).

The desired overall functionality is achieved by the following steps:

### 1. Registration:

When registering the server on the Local Discovery Server LDS, 201 with its internal connection data, 110, (internal host addressing information), its discoveryURI is replaced or updated by the (external) network addressing information, 102 of the (OPC UA) proxy component UAP, 200.

For example, the URI of a single server instance (101) uniquely identified by adding individual URI attributes.

For example:
<internal connection data>:port/path
<FQDN/Host-IP>: 4840/robot,
<FQDN/Host-IP>: 4840/camera

When establishing a connection from a UA client UAC, 100 to one of the (external) network addressing information items (endpoint URIs), 102, for example via HEL (LO) message as specified in the OPC UA standard, the (OPC UA) proxy component UAP, 200 checks: if the server “EndpointURI” specified in the connection request “HEL (LO)” addresses the Local Discovery Server LDS, 201, the connection is forwarded to the latter so that subsequent service requests and responses are answered by the Local Discovery Server LDS.

The above-mentioned OPC UA example is usually the OPC UA services “FindServers” or
“FindServersOnNetwork”.

In the following, a service request refers to the entire communication (e.g. TCP-IP connection), and not only a single OPC UA service request.

If the server “EndpointURI” specified in the connection request “HEL (LO)” addresses a server UAS, 101, the corresponding internal server “EndpointURI” is identified and the establishment of the connection to the internal server “EndpointURI” is continued.

If unsecured service requests and responses are subsequently transmitted via this connection, the proxy component may interfere with these services according to the following rule:

If a connection forwarded by the proxy component UAP, 200 to a services server UAS, 101 is initially still in the normal unsecured mode (i.e. without “secure session”, unencrypted), the proxy component monitors the connection for the transmission of a “GetEndpoints” service request. UA Clients UAC, 100 regularly use the “GetEndpoints” service request to choose between sometimes multiple endpoints offered by servers at the same time. Since the UA servers UAS, 101 only know their internal endpoints, but not the external view with the proxy component UAP, 200, the proxy component must intervene in this service; there are basically multiple, in principle equivalent, design variants:

The proxy component forwards the “GetEndpoints” service request to the relevant UA server UAS, but overwrites (corrects) its service response:
in this case, the internal servers reported by the UA server UAS are replaced by the associated external “EndpointURI”s according to the endpoint information, 111.

If a “GetEndpoint” request from the directory service component, Local Discovery Server, LDS, 201 or proxy component UAP, 201 is carried out on the server, its “EndpointURI”s can be adjusted in advance and stored or cached.

Continuing with the example above:
<external connection data>: port/path
<FQDN/Host-IP>: 4840/<internal connection data′>/Robot,
<FQDN/Host-IP>: 4840/<internal connection data′>/Camera

The following additional versions are possible:

The proxy component UAP, 200 answers the “GetEndpoints” service request itself without forwarding it to the UA server UAS, 101; the already established connection to the UA server UAS is in this case no longer used. The proxy component UAP responds on the basis of the endpoint information, 111 transmitted to it with the external “EndpointURI”s of the addressed services server UAS belonging to the request.

Alternatively, the proxy component UAP, 200 forwards the “GetEndpoints” service request to the directory service component, Local Discovery Server LDS, 201, which answers it with the correct external “EndpointURIs” on behalf of the UA server UAS.

The proxy component UAP, 200 does not intervene in the additional, and later possibly secured, communication between OPC UA Client UAC, 100 and OPC UA server UAS, 101 within the context of a “secure session”.

The various participants in the Industrial Edge ecosystem would like an automatic integration of OPC UA server apps, regardless of the provider. The use of current OPC UA security mechanisms, in particular the so-called “secure sessions”, must also be supported. In order to design the “external” integration in automation applications to be as simple as possible, even with regard to subsequent changes, the externally defined network addressing information should be kept to a minimum in order to avoid addressing conflicts with other apps, for example.

Further advantageous effects result from this.

The proposed method and system will improve and/or simplify the commissioning and security of devices with multiple OPC UA servers, for example by using only one TCP port and the associated simplification of the security measures required in the customer infrastructure.

The dependency of server configuration on OPC UA apps/containers is decoupled from the network connection of the device to the server apps.

This enables OPC UA clients not only to discover the OPC UA server applications installed on an Industrial Edge correctly via OPC UA services, but also to successfully establish connections to them.

TCP port conflicts on devices can be avoided, for example in the case of OPC UA server apps competing for the predefined port 4840.

The error-prone TCP port management (including the security concept) by the user is avoided, in cooperation with the individual OPC UA server app providers—where this is possible.

1. A method for providing services to a service consumer by sequence control components in a sequence control environment, the method comprising:
assigning, each of the services, at least one server component that is formed by a sequence control component that is loadable into the sequence control environment and executed, at the sequence control environment;
accepting, by at least one proxy component of a subnet comprising the sequence control environment, requests from a service consumer; transmitting, by a central directory service component, addressing information valid within the subnet to the at least one proxy component; registering the at least one server component on the central directory service component with internal connection data of the central directory service component, including network addresses and ports visible to the at least one server component;
determining globally valid access information assigned to external network addressing information of the at least one server component that is valid within the subnet; and
modifying the internal connection data using the determined external network addressing information in the central directory service component, so that the at least one proxy component is operable to forward service requests corresponding to modified addressing information to the at least one server component.

2. The method for providing services by means of a of claim 1, further comprising:
receiving, by the at least one proxy component, a service request; and
checking a first unencrypted part of the service request, such that it is determined whether a recipient addressed within the service request is the central directory service component, and that the service request is forwarded to a receiver so that subsequent service requests are answered by the central directory service component.

3. The method of claim 1, further comprising:
receiving, by the at least one proxy component, a service request with a first unencrypted part contained within the service request;
checking whether a recipient addressed within the service request is a services server;
determining address information of the corresponding internal services server; and
continuing establishment of a connection to the determined address information of the internal server component.

4. The method of claim 3, further comprising monitoring, by the at least one proxy component the connection for transmission of further, unsecured service requests.

5. The method of claim 4, further comprising answering, by the at least one proxy component, the service request without forwarding the service request to the services server.

6. The method of claim 4, further comprising forwarding, by the at least one proxy component, the service request to the directory service component, which answers the service request with correct address information on behalf of the addressed services server.

7. The method of claim 3, wherein the services server is addressable via the at least one proxy component.

8. The method of claim 1, wherein each of the services comprises a directory service component, and the registering of the at least one server component on the central directory service component assigned to the respective service takes place with the internal connection data of the central directory service component, including network addresses and ports visible to the at least one server component.

9. (canceled)

10. A system for providing services by sequence control components in a sequence control environment, the system comprising:
at least one server component assigned to each of the services, the at least one server component being formed by a sequence control component that is loadable into the sequence control environment and executed, at the sequence control environment;
at least one proxy component of a subnet comprising the sequence control environment, the at least one proxy component being configured for accepting requests from a service consumer; and
a central directory service component configured for transmitting external network addressing information valid within the subnet to the at least one proxy component, for accepting registration of the at least one server component with internal connection data of the at least one server component, including network addresses and ports visible to the at least one server component, and replacing the internal connection data with determined external network addressing information,
wherein the at least one proxy component is configured to forward service access requests corresponding to modified addressing information to the server components.

11. The system of claim 10, wherein the at least one proxy component is configured as an OPC UA proxy with Local Discovery Server functionality.

12. The system of claim 10, wherein the at least one proxy component is configured to:
receive a service request;
check a first unencrypted part contained within the service request such that it is determined whether a recipient addressed within the service request is the central directory service component; and
forward the service request to a receiver, so that subsequent service requests are answered by the central directory service component.

13. The system of claim 10, wherein the at least one proxy component is configured to:
receive an unencrypted part of the service request;
check whether the recipient addressed within the service request is a services server;
determine the address information of the corresponding internal services server;
continue establishment of a connection to the determined address information of the internal services server.

14. The system of claim 10, wherein the at least one proxy component is configured for monitoring a connection for transmission of further unencrypted parts of a service request.

15. The system of claim 14, wherein the at least one proxy component is configured for answering the service request without forwarding the service request to the services server.

16. The system of claim 14, wherein the at least one proxy component is configured for forwarding the service request to the central directory service component, which answers the service request with correct address information on behalf of the addressed services server.

17. The system of claim 10, wherein the services server can be is addressable via the at least one proxy component.

18. The system of claim 17, wherein the services server is addressable via only one previously specified port of the at least one proxy component.

19. The method of claim 7, wherein the services server is addressable via only one previously specified port of the at least one proxy component.
